(19) United States
(12) Patent Application Publication
(10) Pub. No.: US 2008/0317920 A1
(43) Pub. Date: Dec. 25, 2008

(54) CHILLED DISHES AND PROCESS FOR PREPARING SAME

(75) Inventors: Moez Mohamed Bouraoui, Clifton, NJ (US); Elizabeth Joan Topp, Suffern, NY (US)

Correspondence Address: UNILEVER PATENT GROUP, 800 SYLVAN AVENUE, AG West S. Wing, ENGLEWOOD CLIFFS, NJ, 07632-3100, US

(73) Assignee: Conopco, Inc., d/b/a UNILEVER, Englewood Cliffs, NJ (US)

(21) Appl. No.: 11/764,910

(22) Filed: Jun. 19, 2007

(51) Int. Cl. A23L 1/052; A23B 7/06; A23L 1/212; B65B 3/00

(52) U.S. Cl. 426/392; 426/510; 426/628

(57) ABSTRACT

The present invention is directed to a process for making a microwavable dish comprising vegetables, sauce and a carbohydrate, wherein the dish is Refrigerator-stable after packaging and prior to microwaving, even at a pH of greater than or equal to about 5. The vegetables are provided fresh and/or IQF, heated in water, and steamed. The steamed vegetables are mixed with sauce and carbohydrate components, refrigerated after packaging and prior to microwaving, and maintain good textural, visual and taste characteristics. Specifically, the vegetable component has a Just About Right/Acceptable Texture and a Firmness of at least about 5.46 Kg force.

### FIELD OF THE INVENTION

The present invention is directed to a process for making Refrigerator-stable vegetable-containing dishes with cooked sauce and optionally a carbohydrate component that are suitable for heating in a microwave oven, and dishes produced thereby. More particularly, the resulting mixture of vegetables, sauce and carbohydrate component can be hot packed or heated after packaging. The vegetables of the present invention are uniformly cooked and mixed, and unexpectedly, maintain good textural, visual, and taste characteristics after packaging and refrigerating, and after being heated for serving.

### BACKGROUND OF THE INVENTION

Many consumers enjoy the convenience of ready-to-serve microwavable foods. While microwavable foods that are stored in frozen form may be minimally processed and still achieve microbial stability, such foods which are to be stored at chilled or refrigerated conditions require significantly more harsh temperature and time conditions in order to achieve microbial stability. Unfortunately, many food products, especially vegetables, are cooked and processed in such a way that during and subsequent to being packaged in a microwavable pack, the food products lose their structural integrity as well as their visual and taste characteristics. Particularly, vegetables, like broccoli or peppers, are conventionally treated in such a way that the vegetables lose their textural integrity, including tactile and visual integrity, after processing. Additionally, processing of vegetables of a variety of types, sizes, and densities has proven difficult for uniform mixing thereof.

It is of increasing interest to develop a process for making fresh tasting and ready-to-heat dishes, especially those comprising microwavable vegetables that are to be stored at refrigerated or chilled conditions. Challenges in preparing such dishes include maintaining textural integrity of vegetables. Particularly challenging is textural integrity of broccoli and red peppers which are easy to overcook (thereby resulting in “mushy” texture that is too soft). For broccoli and red peppers, in particular, textural integrity is easy to assess visually (such as by observing peeling of peppers upon overcooking). This invention, therefore, is directed to a process for making microwavable vegetables and dishes with the same. The invention comprises the steps of providing IQF or fresh vegetables, mixing and heating in water, followed by steaming. The resulting vegetables may be mixed with a cooked sauce and/or a carbohydrate component. The resulting mixture is filled into microwavable packaging and the vegetables unexpectedly maintain good textural, visual and taste characteristics for at least about fourteen (14) days, and preferably about one to about two months after packaging and refrigerating, and after being heated for serving.

Additional Information

Efforts have been made for preparing vegetable-containing dishes. In Villota et al., U.S. Application No. 2004/0156960, pasteurization of food products, especially vegetables acidified to a pH of about 4.6 to about 5, for preservation purposes is described.

Other efforts have been disclosed for preparing vegetable products. In EP 0 512 580, a process for the stabilization of color of green vegetables is described.

Even other efforts have been disclosed for preparing vegetable products. In co-pending U.S. Patent Application No. 2007/0,077,335 methods for preparing scalloped potatoes are described.

None of the additional information above describes microwavable dishes with vegetables of different sizes and densities that maintain good textural, visual and taste characteristics after storage for at least fourteen (14) days, and preferably about one to about two months after packaging and refrigerating, and after being heated for serving.

### SUMMARY OF THE INVENTION

In a first aspect, the present invention is directed to a process for preparing a dish comprising vegetables of different sizes and densities, suitable to microwave and comprising the steps of:
I. Processing a vegetable component comprising:
   (a) providing a plurality of IQF and/or fresh vegetables, preferably IQF, of different sizes and densities;
   (b) Heating said vegetables by immersing them in hot water having a temperature of at least about 90° C. (194° F.), preferably about 90° C. to about 100° C., and most preferably about 93° C. (about 200° F.) to about 95° C. and mixing for about 1 minute to about 10 minutes, preferably about 2 minutes; wherein the water and vegetables are mixed in a weight ratio of at least about 1:1, preferably about 2:1; thereby resulting in uniformly mixed vegetables;
   (c) Steaming said uniformly mixed vegetables to a temperature of at least about 90° C. (194° F.), preferably for about 1 to about 10 minutes, more preferably about 3 minutes, to produce steamed vegetables;
II. Providing a sauce component and heating to a temperature from about 70° C. to about 125° C. to produce a heated sauce; preferably about 185° F. to about 200° F. (about 85° C. to about 93° C.);
III. Optionally, providing a carbohydrate component and optionally heating said component;
IV. Combining said vegetable, sauce, and optionally carbohydrate component to produce a mixture either before filling for packaging or during filling for packaging; wherein the temperature of the mixture at the time of filling or after filling is at least 71.11° C. to about 95° C.;
preferably about 175 F (79 C);
wherein said dish is Refrigerator-stable prior to microwaving for at least about fourteen (14) days;
preferably wherein the vegetable has a Just about right/Acceptable Texture; and
a firmness of at least about 5.46 Kg force, preferably at least about 6.07 to about 30 Kg force, more preferably about 6.07 Kg force to about 10 Kg force.

In a second aspect, the present invention is directed to the refrigerator-stable microwavable dish made in the first aspect of this invention. The dish is Refrigerator-stable after packaging and prior to microwaving, even at a pH of greater than or equal to about 5.

Vegetables, as used herein, means a plant or portion thereof cultivated for an edible part, including flower buds like broccoli and cauliflower buds. Other illustrative vegetables suitable for use in this invention include carrots, beets, mushrooms, zucchini, onions, garlic and especially, peppers. Preferably, the process according to the present invention begins with fresh and/or individually quick frozen (IQF) vegetable particulates, more preferably IQF vegetable particulates which have been blanched prior to freezing.

Approximate diameter means the diameter of a cross-section of the vegetable whereby the cross-section of the vegetable is not a perfect circle. The approximate diameter for each type of vegetable in the vegetable mixture according to the present invention is not the same. In fact, it is the difference in sizes and densities of the vegetables that, in part, create the need for the inventive process. All diameters and thickness as discussed herein are taken prior to mixing and heating the vegetable.

Steaming as used herein means contacting plant material with steam until internal temperature reaches at least about 90 deg. C (about 194 deg. F), preferably about 90 deg. C to about 95 deg. C (about 203 deg. F), preferably for about 1 minute to about 10 minutes, more preferably about 3 minutes.

Texture, as used herein, means firmness in Kg force after processing vegetables. Texture testing for broccoli florets is performed using a Texture Technologies TA-XT2i PLUS instrument. A one compression cycle is used to deform or squash the vegetable. The height of the probe (also called the distance between plates) is preset to 10 mm. The sample weight is about 2 grams. A 2″ round probe which compresses the sample travels at a speed of 10 mm/sec. The instrument measures and records the maximum resistive force or firmness.

A firmness of at least about 5.46 Kg force, preferably about 6 to about 30 Kg force, and more preferably about 6.68 Kg force to about 10 Kg force, correlates with Liking Attributes and JAR scale for the vegetable component, and particularly broccoli or broccoli florets in the vegetable component. Acceptable Texture, as used herein, means firmness and integrity, both tactile and visual.

“Just about right” or “JAR” as used herein relates to consumer rating scale for Texture, overall color (not too dark nor too light), number of vegetables pieces (neither too few nor too many), the size of the vegetable pieces in the product (neither too large nor too small), as well as the overall flavor and aroma. For example, on a 5 point scale, a rating of 1 would signify the vegetables are too soft, a rating of 5 signifies the vegetables are too firm, and the closer to 3 the rating, the more perfect the texture in terms of being neither too soft nor too firm. A 95% confidence level is used to test the significance of how different the product attribute rating is from JAR rating of 3.0.

Refrigerator-stable as used herein means a product that is microbially stable during storage at chilled refrigerator temperatures of about 1 deg. C to about 13 deg. C (55.4 deg. F), preferably about 2 deg. C to about 10 deg. C, for at least about fourteen (14) days, preferably at least about fourteen (14) days to at least about one (1) month, more preferably about sixty (60) days to about ninety (90) days, including all ranges subsumed herein.

“Combining before filling for packaging” means making a mixture of vegetable and sauce first, and optionally with carbohydrate component, then filling the mixture into the desired package. “Combining during filling for packaging” means simultaneously making a mixture and filling the desired package or making the mixture in the desired package by filling the desired package first with sauce or vegetable and optionally carbohydrate.

Uniformly mixed and/or cooked means having a similar texture after heating as it relates to refrigerated cooked product and/or uniformly mixed as it relates to vegetable component and/or sauce component and/or carbohydrate component.

The term “comprising” is used herein in its ordinary meaning and means including, made up of, composed of, consisting and/or consisting essentially of. In other words, the term is defined as not being exhaustive of the steps, components, ingredients, or features to which it refers.

Except in the operating and comparative examples, or where otherwise explicitly indicated, all numbers in this description indicating amounts or ratios of material or conditions of reaction, physical properties of materials and/or use are to be understood as modified by the word “about”.

### DETAILED DESCRIPTION OF THE PREFERRED EMBODIMENTS

The process according to the present invention obviates the deficiencies of the prior art discussed above. The inventive process is particularly advantageous at product pH of greater than or equal to about 5, because at lower pH less cooking is required in order to achieve microbial stability. This is because non-proteolytic (NP) bacteria, such as C. Botulinum, cannot grow at the lower pH. For example, NP C. Bot. equivalent lethality can be achieved by maintaining a product at 90° C. (194° F.) for 7 minutes. On the other hand, a pH of about 5 or more is often organoleptically required and cooking too long destroys vegetable integrity and texture. Therefore, the process according to the present invention is particularly suitable for achieving microbial stability for refrigerator storage while providing a vegetable containing product having uniformly mixed and cooked vegetables of Acceptable Texture.

The only limitation with respect to the type of vegetable used in this invention is that the vegetable is one suitable for human consumption. Illustrative non-limiting examples of the type of vegetable that may be used in this invention include a mixture of any combination of broccoli, cauliflower, carrots, beets, zucchini, potato, mushrooms, corn, onions, water chestnuts, green beans, snow peas, green peas, peppers, asparagus and bok choy. In a preferred embodiment, the vegetables have a variety of diameters, including an approximate diameter of about 0.9 cm to about 9 cm, preferably about 1.9 cm to about 3.0 cm, more preferably about 2.5 cm (about 1 inch), and including all ranges subsumed therein.

When preparing the vegetables for the Refrigerator-stable microwavable dish of the present invention, the vegetables are sourced as individually fresh and/or quick frozen (IQF) vegetable particulates, preferably those which have been blanched prior to freezing. Typically, the vegetables have a variety of approximate thicknesses of about 0.25 cm to about 1 cm, preferably about 0.3 cm to about 0.85 cm, more preferably about 0.32 cm to about 0.64 cm, including all ranges subsumed therein.
The table below lists illustrative vegetables, their varying sizes, and their varying densities.

TABLE 1

| | Weight to Fill ½ Cup (g) | | | | | |
|---|---|---|---|---|---|---|
| | | | IQF Carrot | | | |
| | | | (Julienne: | | | |
| | IQF | IQF Sliced | ¼ inch or | IQF Red | | |
| | Broccoli | Water | 0.64 cm | Bell Pepper | | |
| | Florets | Chesnuts | thickness | (¾ inch/1.9 cm | IQF Super | |
| | (¾ to 1 inch | (1″ approximate | and 1½ | approximate | Sweet Corn | |
| | approximate | diam. × 3/16 | inch or | diameter | (approximate | |
| | diameter or | inch thick or | 3.8 cm | and ¼ inch | diameter | |
| | 1.9 cm to | 2.54 cm diam × .48 cm | approximate | or 0.64 cm | <⅜ inch or | |
| | 2.54 cm) | thick) | diameter) | thickness) | 0.95 cm) | Water |
| Average | 44.42 | 57.88 | 59.27 | 55.74 | 71.83 | 114.28 |
| Weight | | | | | | |
| (g) | | | | | | |
| Density | 0.39 | 0.51 | 0.52 | 0.49 | 0.63 | |
| (g/ml) | | | | | | |

Various fresh and/or IQF vegetables are mixed in batches in a mixing vessel, preferably a ribbon mixer, by immersing them in hot water in a weight ratio of at least about 1:1, preferably about 2:1, resulting in uniformly mixed vegetable component. Illustrative examples of the type of mixer suitable for use in this invention include those made commercially available by suppliers like A-One, Blentech Corp., RMF and Scott Equipment. A greater amount of water is possible, depending on target temperature desired. The fresh and/or IQF vegetables are thereby mixed and heated in hot water for about 1 minute to about 10 minutes, preferably about 2 minutes; including all ranges subsumed therein. The water temperature at which the heating takes place is at least about 90° C. (194° F.), preferably about 90° C. to about 100° C. (212° F.), and most preferably about 93° C. (about 200° F.) to about 95° C. Mixing and heating results in uniformly mixed and thawed vegetables. The vegetables are drained prior to the next step of Steaming.

The vegetables are then Steamed to a temperature of at least about 90° C. (194° F.), preferably about 90° C. to about 95° C., preferably for about 1 to about 10 minutes, more preferably about 3 minutes, to produce steamed vegetables. In a preferred embodiment, the texture of the vegetables after preparation is an acceptable texture and the vegetables are uniformly mixed and cooked.

Along with the vegetables and other particulates, a mixture with sauce is prepared in this invention. There is no limitation with respect to the type of sauce that may be used in this invention other than that the sauce is suitable to heat and serve with vegetables. Illustrative and non-limiting examples of the type of sauce that may be used in this invention include pesto sauce, alfredo sauce, a tomato-based sauce, hollandaise sauce, cream or dairy-based sauce, cheese sauce, or chicken, beef or fish flavored gravies. Sauces made available by Unilever under the Bertoli, Ragu and Knorr brands are especially preferred. The sauce (before being combined with vegetable) is typically heated (i.e., cooked) to a temperature from about 70° C. to about 125° C., and preferably, from about 75° C. to about 105° C., and most preferably, from about 80° C. to about 90° C. (194° F.), including all ranges subsumed therein.

Carbohydrate Component

Optionally, but preferably, a carbohydrate component is provided. Carbohydrate component may include rice, pasta, and other ingredients useful for side dishes.

When combining before filling for packaging is desired, a mixing vessel for receiving the heated sauce component, the vegetable component, and optionally the carbohydrate component, may be set up. The same preferably receives vegetable first. The mixing vessel can also be suitable to gently mix manually or mechanically with paddles or arms that turn in a clockwise or counter clockwise direction and rotate from about 2 to about 9, and preferably, from about 3 to 9, and most preferably, from about 4 to about 8 revolutions per minute, including all ranges subsumed therein.

Mixing preferably takes place for about 0.5 minutes to about 3 minutes, and preferably, from about 1 minute to about 1.5 minutes, including all ranges subsumed therein.

The mechanical mixing vessel is preferably a ribbon mixer. In an especially preferred embodiment, the ribbon mixer is hot water jacketed. Illustrative examples of the type of mixer suitable for use in this invention include those made commercially available by suppliers like A-One, Blentech Corp., RMF and Scott Equipment.

Subsequent to uniformly mixing the sauce and vegetable, and optionally the carbohydrate component, the resulting mixture is preferably gravity fed to a filler having nozzles that have openings from about 2.54 cm to about 7.6 cm, and preferably, from about 3.15 cm to about 6.3 cm, and most preferably, from about 3.8 cm to about 5.5 cm, including all ranges subsumed therein. The filler (which preferably comprises a piston pump) then feeds the sauce, vegetable and optionally carbohydrate component mixture into desired packaging.

An alternative to the mix then fill process described above is a two stage filling process that simultaneously combines vegetable and sauce, and optionally carbohydrate, during filling into desired packaging or by filling packaging with vegetable and/or carbohydrate, and subsequently, sauce or sauce, and subsequently, vegetable and/or carbohydrate.

Typically, the mixture fed into the packaging is from about 15 percent to about 75 percent, and preferably, from about 20 to about 40 percent, vegetable component, including all ranges subsumed therein.

Optional Additives

It is also within the scope of this invention to employ optional additives. In addition to vegetables, the present invention optionally employs pieces or particulates of legumes, nuts, fruits, meats (e.g., like, beef, pork, chicken, seafood and/or fish). Further optional additives may include cheese, dairy ingredients like milk, sour cream, oil and margarine, and spices (e.g., salt, pepper), flavors, flavor enhancers, like monosodium glutamate or kelp, and thickeners like yeast and/or agents such as guar gum, xanthan gum, starches or mixtures thereof. Additives preferred for use in this invention include texturizers like disodium phosphate, preservatives like potassium sorbate, as well as antimicrobial agents with nisin.

When optional additives are used, they typically make up less than about 15 percent by weight of the mixture fed into the package.

In a preferred embodiment, the package used in this invention is a glass or polymeric jar, a sachet or a package generally classified as a tub or tray. Such packaging is microwavable and typically suitable for servings of eight or less, and preferably, for one to four servings. In an especially preferred embodiment, the mixture fed to packaging according to this invention is ready-to-heat and microwavable side dishes, such as penne with primavera vegetables in Alfredo sauce. Moreover, at the time of packaging (i.e., via hot packing) or after packaging but while still in production, the sauce and vegetable and/or carbohydrate mixture should be at a temperature from at least about 71.11° C. (160° F.) to about 95° C., and preferably, from about 71.11° C. to about 82° C. (about 180° F.), including all ranges subsumed therein. If hot packing is not desired, the packaged mixture (preferably immediately after sealing, and while in production), can be heated with, for example, hot water, steam, hot air, microwaves or in an oven. Subsequent to finalizing production, the packaged product is preferably cooled (within about 4 hours to about 6 hours) to an internal temperature from about 1° C. to about 5° C. (41° F.), preferably about 1.5° C. to about 4° C., including all ranges subsumed therein. Preferably, cooling is conducted in a spiral freezer for about one (1) hour to about four (4) hours, before final storage at about 35° F. to about 40° F. (about 1.7° C. to about 4.5° C.).

The examples below are provided to facilitate an understanding of the present invention. The examples are not intended to limit the scope of the claims.

### COMPARATIVE EXAMPLE A

### Batch Hot Water Blanching in a Vertical Steam Jacketed Kettle

To a 20 Gallon Counter Agitation Lee kettle, while heating and mixing, 90 pounds of Hot Water (210° F.) were added followed by 7.5 pounds of IQF sliced water chestnuts and 7.5 pounds of IQF julienne carrots. The water temperature dropped to 183° F. After this temperature reached 205° F., 7.5 pounds of IQF broccoli florets and 7.5 pounds of IQF diced red bell peppers were added. The water temperature dropped to 185° F. When the water temperature reached 202° F. (broccoli temperature of 196° F.), heating was turned off but mixing remained on. Product was discharged and pumped through a 3 inch Sine Pump and 3 inch flexible hose to four de-watering colanders where water was removed.

Evaluation of the product revealed Vegetable Uniformity Issues: most water chestnuts were at the first colander and their number decreased significantly in the last colander. Broccoli damage was also observed in the last colander. Therefore, this method was not acceptable.

### COMPARATIVE EXAMPLE B

### Steaming

The IQF vegetables as in Example A were manually blended and steamed for 8 min (until Carrot temperature reached 194° F.). Cooked vegetables were mixed with sauce then cooked rice (15%, 20%, and 65%, respectively), hot filled (>160° F.) using the Pilot Plant Holmatic piston filler (15-16 oz, in Bowls), sealed, inverted, then cooled to 35-40° F. (1.7-4.5° C.).

Evaluation of the product revealed that the Texture of pepper was not acceptable mainly because of peel separation and soft texture. Finished product was deemed unacceptable.

### COMPARATIVE EXAMPLE C

### Hot Water Blanching Followed by Ribbon Mixing with Sauce

As in Example A, vegetables were batch blanched in hot water, de-watered, mixed with sauce in pilot scale Ribbon Mixer, dischargeed, mixed with cooked rice, and hot filled (as in Example B).

Evaluation revealed that finished product was uniform but vegetable color was darker than those obtained in Example B, and there was also a problem of pepper peel separation. Finished product was deemed unacceptable.

The effects of water blanching or steaming on the appearance and texture of vegetables can be summarized as: with each method, skin peeling off from red peppers was observed.

### EXAMPLE 1

### Pre-Heating & Ribbon Mixing Followed by Steaming

The IQF vegetables (mentioned in Example A) were mixed with 200° F. (93.3° C.) hot water (1:3 ratio) in the pilot plant scale Ribbon Mixer for 2 min, discharged, and de-watered in colanders. Uniform blend was obtained. Drained vegetables were batch steamed (7.5 pounds per tray) to heat Carrots from 110 F to 194° F. within 4 minutes, mixed with sauce, and then mixed with cooked spaghetti (30%, 31%, and 39%, respectively), hot filled (>160° F.) using the Pilot Plant Holmatic piston filler (15-16 oz, in Bowls), sealed, inverted, then cooled to 35-40° F.

Evaluation showed that vegetables were uniform with acceptable texture including red peppers. No mushiness was noted.

### EXAMPLE 2

### Alfredo Penne with Primavera Vegetables

Microwavable dishes having mixed vegetables, pasta and a dairy-based sauce were made in the following manner.

Vegetable Processing The process according to the present invention begins with individually quick frozen (IQF) vegetable particulates, preferably those which have been blanched prior to freezing. Vegetables slices having an approximate diameter that varies from about 1.9 cm (about ¾ inches) to 5.1 cm (about 2 inches) and a thickness of about 0.476 cm (0.187 inches), depending on vegetable type, were used. Vegetable densities varied also depending on vegetable type. Broccoli, red bell peppers (preferably cut to about 1.9 cm to about 2.5 cm, or approx ¾ to 1 inch diced), green and yellow zucchini were among the variety of vegetables in the mixture.

Heating. To a Ribbon Mixer, with steam in the jacket run at 50 psi, 700 pounds (about 318 kg) of vegetables and 1500 pounds (about 682 kg) of hot water (>200° F. or >93° C.) were added. Mixing mode was maintained for 2 min. While continuing to mix, the mixture was discharged slowly through a gate to a de-watering conveyor, thereby resulting in blended de-watered vegetables which have been substantially thawed.

Steaming. De-watered vegetables were conveyed to a continuous steamer, where vegetables were heated to 194-197° F. (90-92° C.), for about 3 minutes, followed by discharging the steamed vegetables into insulated totes. Steamed vegetables can be used up to 20 minutes after filling in totes.

Sauce Component and Processing. Dairy-based sauce was made by mixing the following ingredients in a mixer (such as a liquefier or kitchen blender) and heating the resulting mixtures to about 88° C. (about 190° F.) to about 200° F. to produce heated sauces. Sauce can be used up to 40 minutes after reaching 190° F. (88° C.).

TABLE 2

| Ingredient | Percent by Weight* |
|---|---|
| Water | BAL** |
| Milk | 40.00 |
| Cream | 3.00 |
| Butter | 4.00 |
| Cheese | 13.50 |
| Starch | 1.25 |
| Preservatives | 1.15 |
| Spices | 0.50 |
| TOTAL | 100.00 |

*based on total weight of sauce component
**BAL means balance to 100.00%

Carbohydrate Component Processing. Penne pasta was cooked in a rotary hot water blancher for about 6-7 minutes in water having a temperature of 205-208° F. (96-98° C.).

Combining Vegetables Sauce and Carbohydrate Components. Vegetables, pasta and sauces were combined (20% by weight vegetables and 50% by weight sauce, and 30% by weight pasta) by adding sauce and cooked penne to insulated totes already containing vegetables. Penne and sauce were mixed until sauce, including vegetables, were uniformly distributed. The totes were covered and lined up in such a way that the first totes filled were the first ones transferred by gravity to a Holmatic filler hopper (preferably with horizontal agitation at 12 rpm).

Filling and Cooling. The resulting vegetable, pasta and sauce mixtures/product was hot filled into microwavable tubs (14 oz/396 grams/tub to 16 oz/454 grams/tub) at a temperature greater than or equal to 160° F. (71.11° C.). The mixtures of vegetables, pasta and sauce were at a temperature from about 71.1° C. to about 79° C. (about 175° F.) during the filling/hot packing process, and subsequently, sealed. The tubs were inverted and promptly conveyed through a spiral freezer where temperature and dwell time settings cooled product internal temperature to 35-45° F. (1.67-7.22° C.) within 6 hours of filling without freezing it. After the spiral chiller, the product is kept at a temperature of about 35-40° F. (1.67-4.44° C.) during sleeving, casing, palletizing, storage, distribution, and until consumption.

Texture. Texture of the broccoli in the vegetable component was measured to establish a benchmark to compare future consumer trials to. The broccoli was rated as acceptable by an expert panel. The firmness of the broccoli was measured at 6.07 kg, with a standard deviation of 0.61 kg. These measurements correlated with a Sensory Test which indicated texture of broccoli at 2.9 which is not significantly different from the JAR score of 3.0 on on a 5 point JAR scale (95% confidence level).

Sensory Test. Sensory results are summarized in the Table below.

TABLE 3
Attribute Intensity Ratings (5 point “Just About Right”/JAR scales)

| | |
|---|---|
| TEXTURE OF THE YELLOW ZUCCHINI | 2.9 |
| (1 = much too soft; 3 = just about right; 5 = much too firm) | |
| TEXTURE OF THE GREEN ZUCCHINI | 2.9 |
| (1 = much too soft; 3 = just about right; 5 = much too firm) | |
| TEXTURE OF THE BROCCOLI | 2.9 |
| (1 = much too soft; 3 = just about right; 5 = much too firm) | |

Accordingly, this example demonstrates a process and dish according to the present invention.

In view of the positive evaluation, the method of this Example 2 was selected as one according to the present invention. For product where blended pH is below 5.0, method of Example 2 is followed except that heating vegetables to 194 F is not necessary.
The Tables below are sensory score reports for selected product varieties, showing the vegetable texture score was not significantly different (95% confidence level) from the “Just About Right” score of 3.0.

The table below shows an evaluation of Penne Alfredo with Primavera Vegetables: Contains 4% Red Bell Peppers, 3% Yellow Zucchini, 6% Broccoli and 7% Green Zucchini. Total=48% Sauce, 20% Vegetables and 32% Penne.

TABLE 4
Penne Alfredo with Primavera Vegetables
Attribute Intensity Ratings (5 point JAR scales)

| | |
|---|---|
| TEXTURE OF THE YELLOW ZUCCHINI | 3.1 |
| (1 = much too soft; 3 = just about right; 5 = much too firm) | |
| TEXTURE OF THE GREEN ZUCCHINI | 3.1 |
| (1 = much too soft; 3 = just about right; 5 = much too firm) | |
| TEXTURE OF THE BROCCOLI | 3.0 |
| (1 = much too soft; 3 = just about right; 5 = much too firm) | |
| TEXTURE OF THE RED BELL PEPPERS | 2.9 |
| (1 = much too soft; 3 = just about right; 5 = much too firm) | |

The table below shows an evaluation of Asian Rice with Vegetables and Garlic Sauce: white rice, red and yellow bell peppers, water chestnuts, green onions, garlic sauce.

TABLE 5
Asian Rice with Vegetables and Garlic Sauce
Attribute Intensity Ratings (5 point JAR scales)

| | |
|---|---|
| TEXTURE OF THE BELL PEPPERS | 2.9 |
| (1 = much too soft; 3 = just about right; 5 = much too firm) | |

While the present invention has been described herein with some specificity, and with reference to certain preferred embodiments thereof, those of ordinary skill in the art will recognize numerous variations, modifications and substitutions of that which has been described which can be made, and which are within the scope and spirit of the invention. It is intended that all of these modifications and variations be within the scope of the present invention as described and claimed herein, and that the inventions be limited only by the scope of the claims which follow, and that such claims be interpreted as broadly as is reasonable. Throughout this application, various publications have been cited. The entireties of each of these publications are hereby incorporated by reference herein.

What is claimed is:

1. A process for preparing a dish comprising a vegetable component, a sauce component, and optionally a carbohydrate component, said dish being suitable to microwave, and said process comprising:
I. Processing a vegetable component comprising:
i. providing a plurality of vegetables of different sizes and densities;
ii. Heating said vegetables by immersing them in hot water having a temperature of at least about 90° C. (194° F.) and mixing for about 1 minute to about 10 minutes; wherein the water and vegetables are mixed in a weight ratio of at least about 1:1; thereby resulting in uniformly mixed vegetables;
iii. Steaming said uniformly mixed vegetables to a temperature of at least about 90° C. (194° F.) to produce steamed vegetables;
II. Providing a sauce component and heating to a temperature from about 70° C. to about 125° C. to produce a heated sauce;
III. Optionally, providing a carbohydrate component and optionally heating said component;
IV. Combining said vegetable, sauce, and optionally carbohydrate component to produce a mixture either before filling for packaging or during filling for packaging; wherein the temperature of the mixture at the time of filling or after filling is at least 71.11° C. to about 95° C.;
wherein said dish is Refrigerator-stable prior to microwaving for at least about fourteen (14) days; and
wherein said vegetable component has a firmness of at least about 5.46 Kg force.

2. The process according to claim 1 wherein the vegetable component is a mixture comprising any combination of broccoli, cauliflower, peppers, carrots, beets, zucchini, mushrooms, corn, onions, water chestnuts, green beans, snow peas, green peas, potato, asparagus, bok choy.

3. The process according to claim 4 wherein said vegetable component mixture comprises vegetables of differing approximate diameters and thicknesses.

4. The process according to claim 1 wherein the dish comprises from about 15 percent to 75 percent by weight vegetable component.

5. The process according to claim 1 wherein the temperature of the mixture at the time of filling or after filling is from about 71.11° C. to about 82° C.

6. The process according to claim 1 wherein the mixture further comprises rice, pasta, pieces of nuts, fruit, meats, beans, legumes, cheese, oil, spices, flavor enhancer, gum, starch, preservative, anti-microbial agent or a mixture thereof.

7. The process according to claim 1 wherein the mixture is produced prior to filling into packaging and not heated after packaging.

8. The process according to claim 1 wherein the mixture is produced during the filling into packaging and in-pack heated after packaging and sealing.

9. The process according to claim 1 wherein the mixture is packaged and cooled in the package to a temperature from about 1° C. to about 5° C.

10. The process according to claim 1 wherein the vegetable component has an Acceptable Texture.

11. The process according to claim 1 wherein the vegetable component is Just About Right.

12. The microwavable refrigerator stable dish made by the process of claim 1.

13. A dish comprising mixture of a vegetable component, a sauce component, and optionally a carbohydrate component, said dish being suitable to microwave, and wherein:
said vegetable component comprises a plurality of vegetables of different sizes and densities;
said dish is Refrigerator-stable prior to microwaving for about fourteen (14) days to about sixty (60) days; and
said vegetable component has a firmness of at least about 5.46 kg force.

14. The microwavable Refrigerator Stable dish of claim 13, wherein said vegetable component comprised broccoli having a firmness of about 6.07 Kg force.

15. The microwavable Refrigerator Stable dish of claim 13 which is Refrigerator Stable prior to microwaving for one (1) month to about sixty (60) days.

16. A process for preparing a dish comprising a vegetable component, a sauce component and a carbohydrate component, said dish being suitable to microwave, and said process comprising:
I. Processing a vegetable component comprising:
i. providing a plurality of vegetables of different sizes and densities;
ii. Heating said vegetables by immersing them in hot water having a temperature of about 90° C. to about 100° C. and mixing for about 2 minutes; wherein the water and vegetables are mixed in a weight ratio of about 2:1; thereby resulting in uniformly mixed vegetables;
iii. Steaming said uniformly mixed vegetables at a temperature of about 90° C. (194° F.) for about 1 to about 10 minutes to produce steamed vegetables;
II. Providing a sauce component and heating to a temperature from about 70° C. to about 125° C. to produce a heated sauce;
III. Providing a carbohydrate component and heating said component;
IV. Combining said vegetable, sauce and carbohydrate components to produce a mixture either before filling for packaging or during filling for packaging; wherein the temperature of the mixture at the time of filling or after filling is at least 71.11° C. to about 95° C.;
wherein said dish is Refrigerator-stable prior to microwaving for about sixty (60) days;
wherein said vegetable components has a firmness of about 6.07 kg force, has Acceptable Texture, and is Just about right.

17. The process according to claim 1 wherein said vegetables are Heated by immersing them in hot water having a temperature of about 93° C. (about 200° F.) to about 95° C.

18. The process according to claim 1 wherein said dish has a pH of greater than or equal to about 5.
